(19) United States
(12) Patent Application Publication
(10) Pub. No.: US 2012/0293639 A1
(43) Pub. Date: Nov. 22, 2012

(54) SYSTEM AND METHOD FOR CONTROLLING THE DISPLAY OF A STEREOSCOPIC VIDEO STREAM

(75) Inventors: Dario Pennisi, Fiumicino (IT); Antonio Caramelli, Roma (IT)

(73) Assignee: 3DSWITCH S.R.L., Roma (IT)

(21) Appl. No.: 13/520,714

(22) PCT Filed: Jan. 7, 2011
(86) PCT No.: PCT/IB2011/050062

§ 371 Date: Jul. 31, 2012

(30) Foreign Application Priority Data
Jan. 7, 2010 (IT) TO2010A000005

(51) Int. Cl. H04N 13/04

(52) U.S. Cl. 348/53; 348/E13.075

(57) ABSTRACT

A system (1) for displaying a stereoscopic video stream includes a display device (3) for displaying the video stream in a stereoscopic or monoscopic mode. The system also includes stereoscopic glasses (2) for watching in stereoscopic mode the video stream displayed by the display device. The stereoscopic glasses (2) include a sensor (20) which detects the presence of a head when the glasses (2) are being worn, and a transmitter (21) which transmits to the display device (3) a piece of information indicating that the glasses are being worn. The display device (3) receives the piece of information transmitted by the stereoscopic glasses (2) and displays the stereoscopic video stream in monoscopic or stereoscopic mode as a function of the piece of information received.

### TECHNICAL FIELD

The present invention relates in general to stereoscopic display systems. The invention particularly relates to a method for controlling the reproduction of a stereoscopic video stream according to the preamble of claim 1. The invention also relates to a display system implementing such a method.

### PRIOR ART

As known, stereoscopic vision is obtained by using two images relating to corresponding perspectives of the same object, typically a right perspective and a left perspective.

The images relating to these two perspectives (typically referred to as right image and left image) are intended for the right eye and the left eye, respectively, so that the human brain will integrate together both perspectives into one image perceived as being three-dimensional.

The right and left images can be obtained by using a suitable acquisition system (a so-called “stereoscopic camera” with two objectives or a pair of cameras), or else by starting from a first image (e.g. the left image) and then building the other image (e.g. the right image) electronically (by numerical processing).

Many techniques have been developed so far which allow the fruition of 3D contents transmitted through stereoscopic images.

A first known technique alternates over time the visualisation of the right image with the visualisation of the left image.

This technique however suffers from the drawback that the user must wear active glasses (also known as “shutter glasses”), which alternately shade the right eye or the left eye, so that each eye can only see the images associated with a given perspective.

According to another known technique, the right and left images are projected by means of differently polarized light. This may be obtained, for example, by appropriately treating a screen of a television set or by using suitable filters in a projector.

In this case as well, the user must wear suitable glasses (passive ones in this case) fitted with differently polarized lenses, each allowing only either the right or the left image to pass.

In both cases, if the user tries to watch a video stream without wearing these special glasses (hereafter referred to as stereoscopic glasses to distinguish them from normal prescription glasses), the vision will be disturbed and blurred, resulting in the user's eyes getting tired, which may lead to a headache.

For this reason, systems for displaying 3D videos and images exist which allow the user to manually select either monoscopic vision (2D) or stereoscopic vision (3D). Thus, if the user wants to watch 3D contents, then he/she will put on the stereoscopic glasses and select the 3D display mode; otherwise, he/she will select the 2D display mode and will not have to wear the stereoscopic glasses.

On the other hand, the manual adjustment by the user limits the flexibility of use of the stereoscopic device, since it may happen that the user has difficulty in switching the video signal display mode, e.g. because of physical handicaps, or due to the position of the display device, or because the latter is complex to use.

Patent JP1093987A describes a device capable of automatically switching itself between monoscopic and stereoscopic vision based on the signal received from a sensor arranged on the screen, which detects the radiation emitted by an infrared source on the stereoscopic glasses; the video signal is thus displayed in stereoscopic mode only when the sensor detects the infrared radiation. This system suffers from the drawback that it does not distinguish whether the glasses are being worn or not, but only whether the glasses' activation is switched on or off: glasses switched on but not worn may trigger stereoscopic vision even when the user does not want it.

### OBJECTS AND BRIEF DESCRIPTION OF THE INVENTION

It is an object of the present invention to provide a system and a method which solve the problems of the prior art.

It is also an object of the present invention to provide a method for controlling the display of a stereoscopic video stream in a manner as close as possible to the intentions of the people sitting in front of the screen where the stereoscopic video contents are being displayed.

It is a further object of the present invention to provide a method and a system for displaying a stereoscopic video stream which are both efficient and reliable.

These and other objects of the present invention are achieved through a device and a method incorporating the features set out in the appended claims, which are intended as an integral part of the present description.

Aiming at reducing the costs of the display system while at the same time allowing the switching from monoscopic vision to stereoscopic vision only when the user is wearing special glasses, the inventors have thought of applying a sensor to the glasses in order to detect the presence of a head and thus only allow the stereoscopic display mode to be turned on when the glasses are actually being worn.

When the sensor detects the presence of the head, then it will communicate this information to the device adapted to select the video stream display mode.

Advantageously, the sensor is of the capacitive type, so that it can be manufactured and installed on the glasses at low cost while at the same time providing effective head detection. If the glasses are laid open on a table or a non-conductive element (e.g. a sofa), the capacitive sensor will not activate and the video stream will be displayed in monoscopic mode.

Advantageously, communication between the glasses and the display device occurs through infrared rays by exploiting the sensor used in the display device for communicating with a remote control.

In the case of shutter glasses, two different transmission systems are advantageously used for communicating with the display device. A first system is used for transmitting the piece of information about the presence or absence of a head, thus allowing the switching from monoscopic to stereoscopic vision, while the other system, already commonly in use in this kind of glasses, is employed for transmitting the lens shutting synchronism signal.

The head detection information may also be transmitted, for all types of glasses, by radio frequency; advantageously, if the glasses are shutter glasses, the synchronism signal may be transmitted by radio frequency, so that a single reliable device can be used for both receiving and transmitting signals from/to the glasses.

Also advantageously, the above-mentioned sensor and transmitter may be integrated into a detection device which can be secured to the glasses frame, in particular into the temple arms thereof, so as to allow this system to be implemented also on glasses not originally equipped with it.

Also advantageously, the glasses are fitted with an energy consumption control system which allows to optimise the energy consumption of the glasses based on the spectator's head detection.

Further objects and advantages of the present invention will become more apparent from the following detailed description of a few preferred embodiments thereof.

### BRIEF DESCRIPTION OF THE DRAWINGS

Some preferred and advantageous embodiments will now be described by way of non-limiting example with reference to the annexed drawings, wherein:

FIG. 1 shows a person watching a stereoscopic video stream by means of a system according to the present invention.

FIG. 2 shows a pair of stereoscopic glasses according to the present invention.

FIG. 3 shows a block diagram of the electronics installed on the glasses 2.

FIG. 4 shows a block diagram of the electronics installed on the glasses 2 according to a second embodiment of the present invention.

The figures show different aspects and embodiments of the present invention and, where appropriate, similar structures, components, materials and/or elements in the various drawings are designated by similar reference numerals.

### DETAILED DESCRIPTION OF THE INVENTION

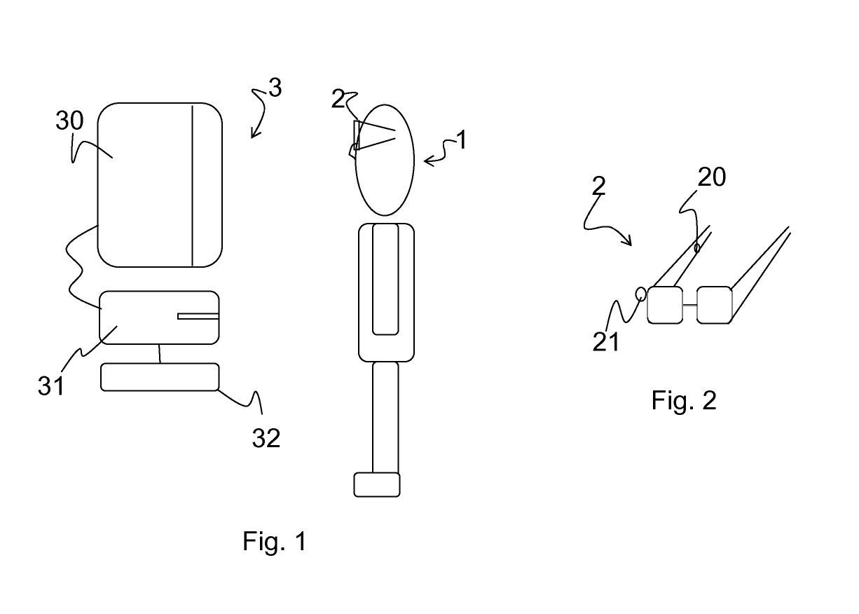

In FIG. 1 a spectator 1 is wearing stereoscopic glasses 2 (shown in detail in FIG. 2) to watch a 3D content, e.g. a movie.

In the example of FIG. 1, the 3D content is displayed on the screen of a display device 3. For the purposes of the present invention, the display device may be any device adapted to display a stereoscopic video stream in stereoscopic or monoscopic mode. Therefore, the term display device refers herein to devices which do not need a screen, such as a projector capable of displaying a video stream on a sheet or a wall, as well as devices comprising a decoder and a screen, such as television sets and computers. The term decoder refers to any device capable of reading optical media (e.g. CD, DVD, Blue-Ray), magnetic media (tape), mass memories, etc. on which 3D contents (in particular stereoscopic video streams) are stored, as well as of providing the screen with the video signals (e.g. RGB signals) necessary for displaying the 3D content. The decoder category also includes set-top boxes, which receive a video stream from an external source, e.g. an antenna or a cable, decode it and output the video signals required for displaying the stereoscopic video stream to a screen, a television set or a projector. Therefore, a decoder may be an external device connected to a screen or else it may be an electronic card, e.g. a video card, integrated into the screen or into a more complex device, such as a computer.

In the example of FIG. 1, the display device 3 comprises a DVD reader 31 connected to a television set 30.

The display device 3 comprises a receiver 32 for receiving from the glasses 2 a signal relating to the presence of the user's head. The receiver 32 may be a radio frequency receiver or an infrared receiver, and may be built in or connected to one of the components of the display device. For example, in one embodiment the receiver 32 may be the infrared receiver of the remote control signal, which receiver is normally present on all television sets, optical readers and set-top boxes.

In the example of FIG. 1, the receiver 32 is an autonomous device connected through a wired connection, in particular via USB, to the DVD reader 31.

In general, if the receiver 32 is separate from the decoder of the display device, the connection between the receiver and the decoder may be either wired or wireless; for example, it may be a radio connection, e.g. Wi-Fi or Bluetooth type.

Depending on the signal received by the receiver 32, the display device automatically selects the video stream display mode; in particular, it will select a stereoscopic mode if the signal indicates that the glasses are being worn and the video stream is stereoscopic, whereas it will select the monoscopic mode in all other cases.

In order to detect if the glasses 2 are being worn or not, the glasses are fitted with a sensor 20 which detects the presence of the head of the user 1.

Preferably, the sensor 20 is a capacitive sensor installed on the glasses frame and facing the area enclosed by the two temple arms of the glasses frame, so that it can detect the head.

In one embodiment, the capacitive sensor is arranged in the proximity of that portion of the glasses frame which rests on the user's ears when the glasses are being worn. In another embodiment, the sensor 20 can be placed on the portion of the glasses frame resting on the user's nose. Both of these solutions are advantageous in that they ensure contact between the head and the sensor.

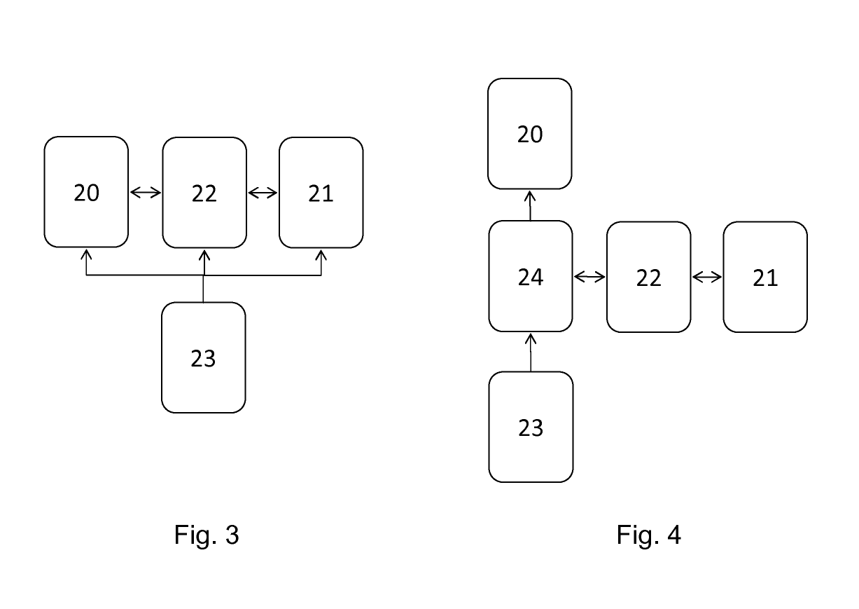

As an alternative, the sensor 20 may be a thermal sensor detecting the presence of the head when it detects a temperature higher than 30° C., preferably higher than 35° C. FIG. 3 shows a block diagram of the electronics installed on the glasses 3.

The sensor 20 is connected to a glasses control device 21, e.g. a processor or a microcontroller, which interprets the sensor's detection and outputs to the transmitter 21 a signal to be transmitted indicating if the glasses are being worn or not.

The transmitter 21 and the receiver 32 are therefore chosen in a manner such that they can communicate with each other.

The sensor 20, the control device 21 and the transmitter 22 are powered by a power supply unit 23 which, in a preferred embodiment, comprises at least one battery ensuring that the glasses are powered properly.

The battery may be charged by using external energy sources or energy harvesting systems, which convert the energy present in the environment, like vibrations, luminous energy or radio waves, into energy which is accumulated in the local battery. A further battery recharging system may consist of an inductive system wherein the display emits radio frequency energy and the glasses receive it and store it into the battery, similarly to RFID systems.

However, in one embodiment the glasses 2 may be equipped with an antenna (e.g. the same antenna of the transmitter 22) to receive radio waves emitted by the display device and be powered by the received signal. This is advantageous because no battery is required, but the user must stay within the cone in which the captured energy received is sufficient to allow the glasses to operate.

In another embodiment, if the glasses are connected to the display device by means of a cable (this is possible, for example, for visors used for 3D games), then the glasses can be powered through the glasses connection cable.

Preferably, the glasses 2 are fitted with an energy management block 24 (shown in FIG. 4), interposed between the power supply unit 23, the sensor 20 and the control unit 22.

The block 24 can automatically switch off the power to the control unit 22 and to the transmitter 21 when the latter are removed, and can automatically activate them when they are put on. In one embodiment, if the glasses are of the shutter type, then the block 24 allows to switch off the power to the other glasses shutting devices, so that the glasses are switched off when they are not being worn, thereby saving energy and ensuring a longer battery life.

The features of the present invention are apparent from the above-description of some embodiments thereof. A man skilled in the art may make many variations or modifications to the above-described display system while still utilising the idea of detecting whether the glasses are being worn or not by means of a sensor installed on the glasses to detect the presence of a head.

For example, if the glasses 2 are shutter glasses, then they must receive a synchronism signal from the display device. Preferably, the indication of the presence of the user's head by the glasses and the synchronism signal to control the shutting of the lenses are transmitted by using different communication systems. For example, the synchronism signal is transmitted through infrared rays, while the signal indicating that the glasses are being worn is transmitted by radio frequency. Alternatively, both signals may be transmitted by infrared communication, but with different codes, so that any interference is reduced to a minimum. Advantageously, if the glasses are of the shutter type and must receive a synchronism signal, then the head detection signal may be transmitted by radio frequency, so that a single reliable device can be used for receiving and transmitting signals from/to the glasses.

Furthermore, the glasses may be equipped with multiple sensors.

In one variant, the above-described electronics of the glasses 2 (sensor, power supply, energy management block, transmitter, etc.) may be integrated into a single reception device distinct from the glasses, which can be secured to the latter through a suitable removable fastening system. This allows said device to be applied to any type of glasses, even passive glasses.

Finally, it is conceivable to provide the glasses with an additional device which further reduces battery consumption. In particular, a tilt sensor (e.g. an accelerometer) may read the tilt angle of the glasses to detect when they are taken in hand, and consequently enable the supply of power to the glasses, including the capacitive sensor section. To this end, the tilt sensor may operate a switch that connects the glasses electronics to the power supply depending on the output of the tilt sensor.

1. A system (1) for displaying a stereoscopic video stream, comprising
a display device (3) for displaying said video stream in a stereoscopic or monoscopic mode,
stereoscopic glasses (2) for watching in stereoscopic mode the video stream displayed by said display device, wherein said display device (3) is adapted to receive a piece of information transmitted by the stereoscopic glasses (2) and to display said stereoscopic video stream in monoscopic or stereoscopic mode as a function of said piece of information,
characterised in that
said stereoscopic glasses (2) comprise a sensor (20) adapted to detect the presence of a head when the glasses (2) are being worn, a control device (22) adapted to receive said sensor's (20) detection and to output a signal indicating if the glasses (2) are being worn, and a transmitter (21) adapted to transmit to said display device (3) a piece of information indicating that the glasses (2) are being worn.

2. A system according to claim 1, wherein said sensor (20) is a capacitive sensor.

3. A system according to claim 1, wherein said sensor (20) is installed on the glasses' frame, in particular on the portion thereof resting on the user's ears.

4. A system according to claim 1, wherein said sensor (20) is installed on the glasses' frame, in particular on the portion thereof resting on the user's nose.

5. A system according to claim 1, wherein said sensor (20) is powered by a battery.

6. A system according to claim 1, wherein said sensor comprises an antenna and is powered through a radio signal received by said antenna.

7. A system according to claim 1, wherein said glasses (2) are of the shutter type and comprise a receiver adapted to receive a synchronism signal from said display device (3) through a first communication system, and wherein said transmitter (21) is adapted to transmit said piece of information indicating that the glasses (2) are being worn through a second communication system different from said first communication system.

8. A system according to claim 1, wherein said transmitter transmits by radio frequency.

9. A system according to claim 1, wherein said stereoscopic glasses (2) further comprise a power management block (24) interposed between a power supply unit (23), said sensor (20) and said control device (22) adapted to control said transmitter (21), said power management block (24) being adapted to automatically switch off the power to the control device (22) if said sensor does not detect a head, and to automatically switch on the power to the control unit when a head is detected.

10. A system according to claim 1, wherein said display device (3) comprises a receiver (32) for receiving signals from both a remote control and said transmitter (21).

11. A system according to claim 1, further comprising a tilt sensor, in particular an accelerometer, adapted to detect any change in the tilt of the glasses and to allow the glasses electronics to be switched on or off when the glasses are picked up in hand.

12. A method for displaying a video stream, comprising the steps of:
detecting if the glasses are being worn through a sensor (20) installed on stereoscopic glasses (2) and adapted to detect the presence of a head,
receiving said sensor's (20) detection and outputting a signal indicating if the glasses are being worn,
transmitting to a display device (3) a piece of information indicating that the glasses are being worn,
displaying said video stream in a stereoscopic display mode if said glasses are being worn.

13. A method according to claim 12, wherein said sensor (20) is a capacitive sensor.

14. A detection device characterised by comprising:
removable fastening means for securing said device to the glasses frame,
a sensor (20) arranged in a manner such that, when said device is secured to said glasses, said sensor is adapted to detect the presence of a head when the glasses (2) are being worn,
a control device (22) adapted to receive said sensor's (20) detection and to output a signal indicating if the glasses are being worn, and
a transmitter (21) adapted to transmit a piece of information indicating that the glasses are being worn.

15. A device according to claim 14, further comprising a power management block (24) interposed between a power supply unit (23) of said device, said sensor (20) and said control device (22), said power management block (24) being adapted to automatically switch off the power to the control device (22) if said sensor does not detect a head, and to automatically switch on the power to the control unit when a head is detected.
